(19) United States
(12) Patent Application Publication
(10) Pub. No.: US 2011/0276345 A1
(43) Pub. Date: Nov. 10, 2011

(54) Healthcare System

(75) Inventors: Tzu-Ming WANG, Kaohsiung County (TW); Kai-Cheng CHUANG, Tainan City (TW); Po-Wen Hsiao, Hsinchu City (TW); Gwo-Feng Hwang, Hsinchu County (TW)

(73) Assignee: E INK HOLDINGS INC., HSINCHU (TW)

(21) Appl. No.: 12/849,816

(22) Filed: Aug. 4, 2010

(30) Foreign Application Priority Data
May 7, 2010 (TW) 99114673

(51) Int. Cl. G06Q 50/00

(52) U.S. Cl. 705/3

(57) ABSTRACT

The healthcare system comprises at least one detector and an analyzer. The detector detects physiological parameters of a patient. The detector has a fist wireless module and a first electronic paper display. The first electronic paper display displays the physiological parameters. The analyzer has a second wireless module to communicate with the first wireless module and a second electronic paper display. The analyzer receives the physiological parameters and displays the physiological parameters on the second electronic paper display. The medical and nursing staff can input doctor's advice in the second electronic paper display based on the physiological parameters and sends the dioctor's advice to the first electronic paper display.

### RELATED APPLICATIONS

This application claims priority to Taiwan Application Serial Number 99114673, filed May 7, 2010, which is herein incorporated by reference.

### BACKGROUND

1. Field of Invention

The present invention relates to a Healthcare system. More particularly, the present invention relates to a Health system with an electronic paper display.

2. Description of Related Art

Typically, healthcare devices, such as blood-pressure meters, oximeters and thermometers, detect physiological parameters, such as blood-pressure, oxygen saturation of a patient's blood or or body temperature. These devices are always used independently of each other and show the corresponding physiological parameters in their displays. That is, these physiological parameters cannot be integrated together and be sent to a remote recording device where the data is consolidated. Therefore, when medical and nursing staff want to decide a treatment based on these physiological parameters, they need to collect these parameters from different apparatus, which is very inconvenient and inefficient and thereby restricting the speed with which the medical and nursing staff can respond.

On the other hand, even though these devices can detect physiological parameters automatically, the medical and nursing staff still walk to these detecting apparatuses to read the measurements from the device display. Such devices cannot help the medical and nursing staff to reduce their burden. Moreover, the possiblility that the the medical and nursing staff get infected by a virus is increased when they walk to clear the patient to collect these parameters.

Moreover, typically, the patient is informed to take medicine by the medical and nursing staff. That is, the patient is passive in taking medicine. Once the medical and nursing staff forget to inform the patient to take medicine, the patient will miss the right time to take medicine.

Therefore, a new healthcare system is developed to solve the foregoing problems.

### SUMMARY

This invention provides a healthcare system to help the medical and nursing staff to remote detector the patient.

Accordingly, the healthcare system comprises at least one detector and an analyzer. The detector detects physiological parameters of a patient. The detector has a fist wireless module and a first electronic paper display. The first electronic paper display displays the physiological parameters. The analyzer has a second wireless module to communicate with the first wireless module and a second electronic paper display. The analyzer receives the physiological parameters and displays the physiological parameters on the second electronic paper display. The medical and nursing staff can input doctor's advice in the second electronic paper display based on the physiological parameters and sends the dioctor's advice to the first electronic paper display.

In an embodiment, the first wireless module is integrated into or inserted to the detector, and the second wireless module is integrated into or inserted to the analyzer. The first wireless module and the second wireless module are Bluetooth modules or radio frequency transmission modules.

In an embodiment, the detector is a blood pressure meter, an electrocardiogram meter, a thermometer, a Glucose meter, an oximeter, a body fat meter or a meter that can detect a physiological parameter. The detector further comprises an audio and a memory. The audio can broadcast the doctor's advice to the patient. The memory stores the time to take the medicine of the patient. The audio can inform the patient to take the medicine based on the time.

Accordingly, the electronic paper display is used in the healthcare system. Because the electronic paper display has the characteristic of light weight and thin volume, it is easy for the medical and nursing staff to carry. Therefore, such system help the medical and nursing staff to process a remote control for the patient.

### BRIEF DESCRIPTION OF THE DRAWINGS

The invention can be more fully understood by reading the following detailed description of the embodiments, with reference made to the accompanying drawings as follows:

FIG. 1 illustrates a schematic diagram of an electronic paper display.

FIG. 2 illustrates a healthcare system according to the first embodiment of the present invention.

FIG. 3 illustrates a schematic diagram of a healthcare detector according to another embodiment of the present invention.

### DETAILED DESCRIPTION

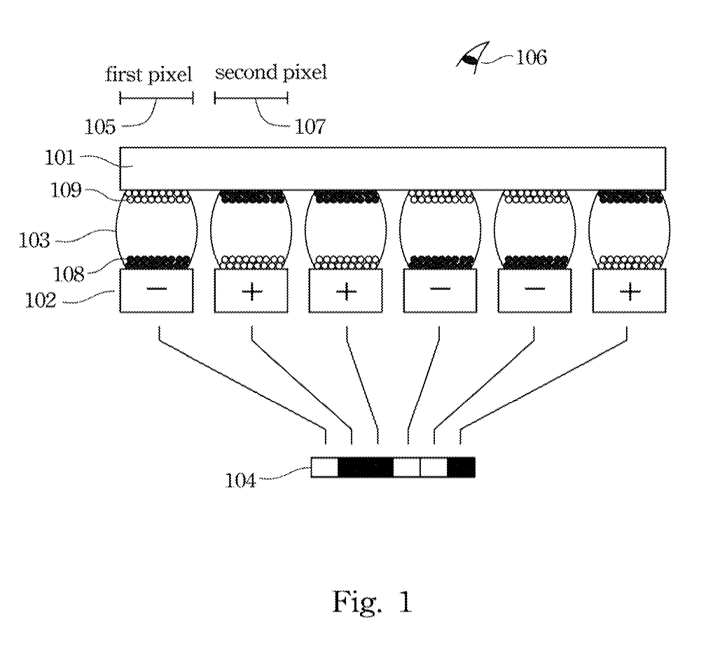

FIG. 1 illustrates a schematic diagram of an electronic paper display. The electronic paper display includes two glass substrates 101 and 102 and an electronic ink layer 103 located between the two glass substrates 101 and 102. A common electrode is formed over the glass substrate 101. A plurality of electrodes is formed in the glass substrate 102. The glass substrates 101 and 102 can be replaced by plastic substrates. The electronic ink layer 103 includes a plurality of microcapsules whose diameter is about 50 micrometer-70 micrometer. Each microcapsule includes black particles 108 and white particles 109. When the electrodes in the glass substrate 102 are charged, the charged electrodes can move up or down the black particles 108 and white particles 109 to display a black-white image in the visual side 106.

For example, a white-black-black-white-white-black display 104 is displayed. The black particles 108 are positive electrical charged and the white particles 109 are negative electrical charged. Accordingly, in the first pixel 105, a white color image is displayed in the visual side 106. Therefore, an electrode in the first pixel 105 in the glass substrate 102 is charged to form a negative electrode to absorb the positive electrical charged black particles 108 and repulse the negative electrical charged white particles 109. That is, the white particles 109 are arranged in the visual side 106 to display white color. In the second pixel 107, a black color image is displayed in the visual side 106. Therefore, an electrode in the first pixel 105 in the glass substrate 102 is charged to form a positive electrode to absorb the negative electrical charged white particles 109 and repulse the positive electrical charged black particles 108. That is, the black particles 108 are arranged in the visual side 106 to display black color. The rest may be deduced by analogy.

Accordingly, the electronic paper display can reflect the environmental light. Therefore, it is not necessary for the electronic paper display to use the back light source. Moreover, an Electrophoretic principle is used in the electronic paper display to display the black-white image. Therefore, the electronic paper display has a bistable characteristic. That is, the electrodes in the glass substrate 102 are charged only when the image is refreshed. In other words, when the image is not refreshed, it is not necessary to charge the electrodes in the glass substrate 102. Therefore, the electronic paper display almost does not consume any power when a same image is displayed. Moreover, the electronic paper display can be wound. Therefore, the electronic paper display can be used in any environment. The electronic paper display is used in the healthcare system of the present invention.

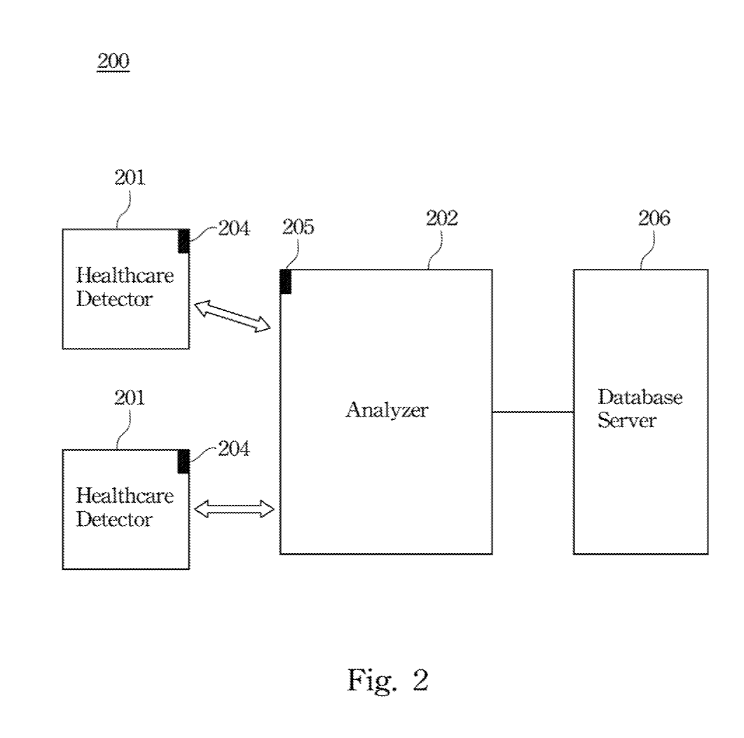

FIG. 2 illustrates a healthcare system according to the first embodiment of the present invention. The healthcare system 200 includes a plurality of healthcare detectors 201, an analyzer 202 and a database server 206. Each of the healthcare detector 201 and the analyzer 202 have the electronic paper display. The database server 206 stores the history anamnesis of patient. The healthcare detector 201 communicates with the analyzer 202 by wireless. In other words, wireless modules 204 and 205 are equipped in the healthcare detector 201 and the analyzer 202 respectively. In an embodiment, the wireless modules 204 and 205 are Bluetooth modules or radio frequency transmission modules. The wireless modules 204 and 205 are integrated into or inserted to the healthcare detector 201 and the analyzer 202 respectively to communicate with them. Accordingly, the data, such as a detecting time, a detecting result, a patient name and so on, detected by the healthcare detector 201 are transmitted to the analyzer 202 by wireless modules 204 and 205. Similarly, the medical and nursing staff also can send the prescription or the doctor's advice from the analyzer 202 to the healthcare detector 201 by wireless modules 204 and 205.

The healthcare detector 201, in an embodiment, is a blood pressure meter, an electrocardiogram meter, a thermometer, a Glucose meter, an oximeter, a body fat meter or a meter that can detect a physiological parameter. In another embodiment, some of these meters can be integrated together to form a healthcare detector 201. According to the present invention, the healthcare detector 201 has an electronic paper display. Because the electronic paper display is wound, the healthcare detector 201 can be located more close to the detected region of the body of the patient to get an accurate detect result. The detect result is transmitted from the healthcare detector 201 to the analyzer 202 by wireless modules 204 and 205.

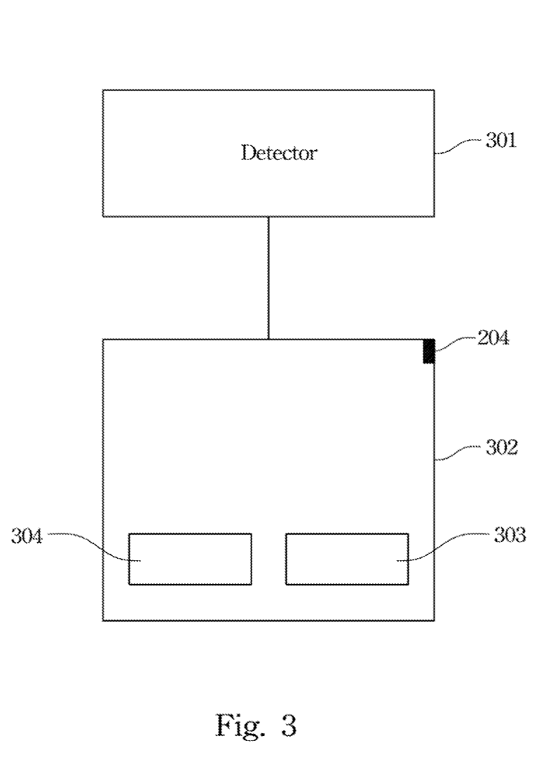

FIG. 3 illustrates a schematic diagram of a healthcare detector according to another embodiment of the present invention. In an embodiment, the healthcare detector 210 includes a detector 301 and a display 302 separated from the detector 301. The wireless module 204 is integrated into or inserted to the display 302. The display 302 is disposed in the hand of the patient. Because the display 302 is an electronic paper display and is wound, the display 302 is located more close to the hand to get an accurate detect result. The detector 301 is a blood pressure meter, an electrocardiogram meter, a thermometer, a Glucose meter, an oximeter, a body fat meter or a meter that can detect a physiological parameter. In another embodiment, some of these meters can be integrated together to form the detector 301. The data, such as a detecting time, a detecting result, a patient name and so on, detected by the detector 301 is transmitted to the display 302 to display. Then, the data is transmitted to the analyzer 202 from the display 302 by wireless modules 204 and 205. On the other hand, the display 302 further comprises an audio apparatus 303 and a memory 304. The memory 304 stores the time to take medicine of the patient and the information of the medicine. In an embodiment, the audio apparatus 303 can inform the patient the information of the medicine and to take medicine based on the time stored in the memory 304. In another embodiment, the audio apparatus further inform the patient the detect result detected by the detector 301.

The analyzer 202 includes an electronic paper display with a wireless module 205 to communicate with the database server 206 and the healthcare detector 201. In an embodiment, the data detected by the healthcare detector 201 is transmitted to the analyzer 202 by wireless modules 204 and 205. The medical and nursing staff can set the prescription or the doctor's advice on the electronic paper display of the analyzer 202. Then, the set prescription or the doctor's advice is sent back to the healthcare detector 201 to display by wireless modules 204 and 205. The prescription or the doctor's advice is displayed in the display of the analyzer 202 to inform the patient. Such system can help the medical and nursing staff to remote monitor the patient in real time.

Moreover, the analyzer 202 also communicates with the database server 206. Accordingly, the medical and nursing staff can upload the data received by the analyzer 202 to the database server 206 to update the information of the patient. Or, the medical and nursing staff can download the history anamnesis from the database server 206 to the analyzer 202. Therefore, it is not necessary for the medical and nursing staff to carry anamnesis. Moreover, it is not a heavy burden for the medical and nursing staff to carry the analyzer 202 because the electronic paper display is used in the analyzer 202 and the electronic paper is light and thin. On the other hand, the electronic paper display almost does not consume any power when a same image is displayed. Therefore, the analyzer 202 can be used for a long time. The medical and nursing staff can set the time for the patient to take the medicine in the healthcare detector 201. Then, the audio 303 can inform the patient to take the medicine based on the set schedule.

Accordingly, the electronic paper display is used in the healthcare system. Because the electronic paper display is light and thin, it is easy for the medical and nursing staff to carry. Therefore, such a system helps the medical and nursing staff to process a remote control for the patient. Moreover, the physiological parameters can be sent to the medical and nursing staff in real time. Then, the medical and nursing staff can make a response based on the physiology parameter, which improve the healthcare quality.

Although the present invention has been described in considerable detail with reference to certain embodiments thereof, other embodiments are possible. Therefore, it will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A healthcare system, comprising:
a detector for detecting physiological parameters of a patient, wherein the detector has a fist wireless module and a first electronic paper display, wherein the first electronic paper display displays the physiological parameters; and
an analyzer having a second wireless module to communicate with the first wireless module and a second electronic paper display, wherein the analyzer receive the physiological parameters and display the physiological parameters on the second electronic paper display;
wherein medical and nursing staff can input doctor's advice in the second electronic paper display based on the physiological parameters and send the dioctor's advice to the first electronic paper display.

2. The system of claim 1, wherein the first wireless module is integrated into or inserted to the detector.

3. The system of claim 1, wherein the second wireless module is integrated into or inserted to the analyzer.

4. The system of claim 1, wherein the detector is a blood pressure meter, an electrocardiogram meter, a thermometer, a Glucose meter, an oximeter, a body fat meter or a meter that can detect a physiological parameter.

5. The system of claim 1, further comprising a database server to store a plurality of patient data, wherein the analyzer can upload or download the patient data.

6. The system of claim 1, wherein the detector further comprises an audio to broadcast the doctor's advice.

7. The system of claim 6, wherein the detector further comprises a memory to store a time to take the medicine of the patient, the audio can inform the patient to take the medicine based on the time.

8. The system of claim 1, wherein the first wireless module and the second wireless module are Bluetooth modules or radio frequency transmission modules.

9. The system of claim 1, wherein the first wireless module is equipped in the first electronic paper display and the second wireless module is equipped in the second electronic paper display, wherein the first electronic paper display can communicate with the second electronic paper display by the first wireless module and the second wireless module.

10. The system of claim 1, further comprising a plurality of detector, wherein each of the detectors has a fist wireless module and a first electronic paper display to communicate with the second electronic paper display of the analyzer.
